(19) United States
(12) Patent Application Publication
(10) Pub. No.: US 2024/0182748 A1
(43) Pub. Date: Jun. 6, 2024

(54) COMPOSITION AND A PROCESS FOR FORMING AN INSULATED MEMBER USING THE SAME

(71) Applicant: WACKER CHEMIE AG, Munich (DE)

(72) Inventors: Detlef Klingberg, Sylvania, OH (US); Ragin Amrutiya, Yorba Linda, CA (US)

(73) Assignee: Wacker Chemie AG, Munich (DE)

(21) Appl. No.: 18/286,412

(22) PCT Filed: Apr. 12, 2021
(86) PCT No.: PCT/EP2021/059463

§ 371 Date: Oct. 11, 2023

(51) Int. Cl. C09D 183/04; C08G 77/04; C08G 77/16; C08G 77/20; C08J 9/22; C08L 83/04; H01B 3/46

(52) U.S. Cl. CPC C09D 183/04; C08G 77/04; C08G 77/16; C08G 77/20; C08J 9/22; C08L 83/04; H01B 3/46; C08J 2383/04; C08J 2483/04

(57) ABSTRACT

A composition includes a curable organopolysiloxane material and at least one of a metal oxide selected from a group consisting of magnesium oxide, aluminum oxide, tin oxide, calcium oxide, titanium oxide and barium oxide, a metal-containing compound which produces a metal oxide of the group on heating, boric acid, or zinc borate. The composition includes a platinum complex containing at least one unsaturated group. The composition also includes hollow filler members.

The invention relates in general to a silicone composition. The invention also relates to a process for forming a member using the same, and members made from the same.

Silicone materials are utilized in many applications including insulating and fire safety applications. Fire resistant communication cables require an insulating layer that is resilient, has a high heat reflection, and exhibits a low dielectric constant. Known silicone materials are not utilized to form such insulating layers because they do not exhibit suitable heat reflection and dielectric constant properties.

Therefore, it would be desirable to provide a composition that overcomes the aforementioned deficiencies.

Embodiments of a composition are provided.

In an embodiment, the composition comprises a curable organopolysiloxane material and at least one of a metal oxide selected from a group consisting of magnesium oxide, aluminum oxide, tin oxide, calcium oxide, titanium oxide and barium oxide, a metal-containing compound which produces a metal oxide of the group on heating, boric acid, or zinc borate. The composition comprises a platinum complex containing at least one unsaturated group. The composition also comprises hollow filler members.

In certain embodiments, the hollow filler members comprise a plurality of unexpanded microspheres, pre-expanded microspheres, or a mixture thereof. Thus, in an embodiment, the composition comprises the plurality of pre-expanded microspheres. In this embodiment, the plurality of pre-expanded microspheres may have a D50 value of 10-500 μm. In other embodiments, the plurality of microspheres is present in an amount of 0.01-5 parts by weight based on 100 parts by weight of the curable organopolysiloxane material.

In some embodiments, the curable organopolysiloxane material is peroxidically crosslinkable or condensation crosslinkable. In other embodiments, the curable organopolysiloxane material comprises a vinyl-functional organopolysiloxane and a silanol-functional organopolysiloxane.

In some embodiments, the platinum complex is a platinum-vinyl siloxane complex. In one such embodiment, the platinum-vinyl siloxane complex is a platinum-1,3-divinyl-1, 1,3,3-tetramethyldisiloxane complex.

Preferably, the composition comprises a reinforcing filler, a nonreinforcing filler, or mixture thereof.

In some embodiments, the composition exhibits a dielectric constant of 2.8 or less.

In other embodiments, the composition produces a ceramic material at temperatures of 610° C. or more.

Preferably, the composition comprises a reinforcing filler, a nonreinforcing filler, or mixture thereof. In an embodiment, the reinforcing filler comprises silica.

Embodiments of a process for forming an insulated member are provided. In one such embodiment, the process comprises forming a composition by mixing components of the composition. The composition is extruded onto an elongated conductive member and the composition is cured.

Preferably, the composition is cured at a temperature of 125° C. or more.

In some embodiments, the composition is disposed around the elongated conductive member and, after curing, forms an insulating layer that exhibits a dielectric constant of 2.8 or less.

Additionally, embodiments of a cable and embodiments of a profile, each comprising the composition are provided.

It is to be understood that the invention may assume various alternative compositions and step sequences, except where expressly specified to the contrary. It is also to be understood that the specific components, members, and methods described in the following specification are simply exemplary embodiments of the inventive concepts. Hence, specific properties, conditions, or other physical characteristics relating to the embodiments disclosed are not to be considered as limiting, unless expressly stated otherwise.

In an embodiment, a composition is provided. The composition is suitable for use in fire safety applications such as, for example, in forming an insulating layer for a cable. Cables including the composition may include circuit integrity cables, communication cables, and other cables that need to function as intended during a rapid rise in temperature. However, the composition may also be suitable in other applications such as, for example, for use in profiles or forming other members.

Preferably, the composition comprises an organopolysiloxane material. In some embodiments, the organopolysiloxane material may be composed of units of the general formula (I)

$${R}_{r} {SiO}_{\frac{4 - r}{2}} \qquad ( I )$$

where R may be identical or different and are unsubstituted or substituted hydrocarbon radicals, and
r is 0, 1, 2 or 3 and has an average numerical value of from 1.9 to 2.1.

Examples of hydrocarbon radicals R are alkyl radicals such as the methyl, ethyl, n-propyl, isopropyl, n-butyl, isobutyl, tert-butyl, n-pentyl, isopentyl, neopentyl or tert-pentyl radicals, hexyl radicals such as the n-hexyl radical, heptyl radicals such as the n- heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, octadecyl radicals such as the n-octadecyl radical; cycloalkyl radicals such as cyclopentyl, cyclohexyl and cycloheptyl radicals and methylcyclohexyl radicals; aryl radicals such as the phenyl, biphenyl, naphthyl, anthryl and phenanthryl radicals; alkaryl radicals such as o-, m- or p-tolyl radicals, xylyl radicals and ethylphenyl radicals; and aralkyl radicals such as the benzyl radical and the α- and the β-phenylethyl radicals.

Examples of substituted hydrocarbon radicals R are halogenated alkyl radicals, such as the 3-chloropropyl radical, the 3,3,3-trifluoropropyl radical and the perfluorohexylethyl radical, and halogenated aryl radicals, such as the p-chlorophenyl radical and the p-chlorobenzyl radical.

Other examples of radicals R are the vinyl, allyl, methallyl, 1-propenyl, 1-butenyl and 1-pentenyl radicals, and the 5-hexenyl, butadienyl, hexadienyl, cyclopentenyl, cyclopentadienyl, cyclohexenyl, ethynyl, propargyl and 1-propynyl radicals.

The radicals R are preferably hydrogen atoms or hydro-carbon radicals having from 1 to 8 carbon atoms, particularly preferably the methyl radical. In some embodiments, it may be preferred that the radicals R are alkenyl radicals having from 2 to 8 carbon atoms, particularly preferably the vinyl radical. Among unsubstituted or substituted hydrocarbon radicals having from 1 to 8 carbon atoms, particular preference is given to the methyl, vinyl, phenyl or 3,3,3-trifluoropropyl radical.

Preferably, alkyl radicals, in particular methyl radicals, are bonded to at least 70 mole percentage (mol %) of the Si atoms present in the organopolysiloxane material composed of units of the formula (I). If the organopolysiloxane material contains, in addition to Si-bonded methyl and/or 3,3,3-trifluoropropyl radicals, Si-bonded vinyl and/or phenyl radicals, the amounts of these latter are preferably from 0.001 to 30 mol %.

Preferably, the organopolysiloxane material may be composed predominantly of diorganosiloxane units. The end groups of the organopolysiloxanes may be trialkylsiloxy groups, in particular the trimethylsiloxy radical or the dimethylvinyl-siloxy radical. However, it is also possible for one or more of these alkyl groups to have been replaced by hydroxyl groups or alkoxy groups, such as methoxy or ethoxy radicals. In some embodiments, the organopolysiloxane material may comprise a mixture of organosiloxanes. For example, in certain embodiments, the organopolysiloxane material may comprise a vinyl-functional organopolysiloxane and a silanol-functional organopolysiloxane.

The organopolysiloxane material may be a liquid or a high-viscosity substance. The organopolysiloxane material preferably has a viscosity of from 10³ to 10⁸ mm²/s at 25° C. However, the organopolysiloxane material is curable.

The organopolysiloxane material may be cured by way of peroxidical crosslinking or a condensation crosslinking. Suitable crosslinking agents are utilized to crosslink the organopolysiloxane material. In some embodiments, a peroxide crosslinking agent is utilized to crosslink the organopolysiloxane material. Suitable peroxide crosslinking agents preferably comprise peroxides such as, for example, dibenzoyl peroxide, bis(2,4-dichlorobenzoyl) peroxide, dicumyl peroxide or 2,5-bis(tert-butylperoxy)-2,5-dimethylhexane, or else mixtures of these, preferably bis(2,4-dichlorobenzoyl) peroxide or 2,5-bis(tert-butylperoxy)-2,5-dimethyl-hexane. Preferably, the crosslinking agent comprises a mixture of bis(4-methylbenzoyl) peroxide (PMBP) and 2,5-dimethyl-2,5-di-tert-butylhexane peroxide (DHBP) in a ratio of from 1:0.4 to 0.5:1, preferably in a ratio of 1:0.4.

The organopolysiloxane material may contain a reinforcing and/or a nonreinforcing filler. Examples of suitable reinforcing fillers are pyrogenic or precipitated silicas with BET surface areas of at least 50 m²/g. The silica fillers mentioned may have hydrophilic properties or may have been hydrophobicized by known processes such as the one described in, for example, U.S. Pat. No. 5,057,151. In such cases the hydrophobicization is generally carried out using from 1 to 20% by weight of hexamethyldisilazane and/or divinyltetramethyldisilazane and from 0.5 to 5% by weight of water, based in each case on the total weight of the organopolysiloxane material. These reagents are advantageously fed to a suitable mixing apparatus, e.g., a kneader or internal mixer, in which there is an initial charge of the organopolysiloxane material, prior to gradual incorporation of the reinforcing filler.

Examples of non-reinforcing fillers are powdered quartz, diatomaceous earth, calcium silicate, zirconium silicate, zeolites, metal oxide powders, such as aluminum oxide, titanium oxide, iron oxide or zinc oxide, barium silicate, barium sulfate, calcium carbonate, gypsum, and also synthetic polymer powders, such as polyacrylonitrile powder or polytetrafluoroethylene powder. The fillers used may also comprise fibrous components, such as glass fibers or synthetic polymer fibers. The BET surface area of these fillers is preferably less than 50 m²/g.

The amount of filler present in the organopolysiloxane material is preferably from 1 to 200 parts by weight, particularly preferably from 30 to 100 parts by weight, based in each case on 100 parts by weight of organopolysiloxane material.

Depending on the particular application, additives, such as workability aids, for example plasticizers, pigments, or stabilizers, e.g. heat stabilizers, may be added to the organopolysiloxane material, which can be crosslinked or vulcanized to give an elastomer. Examples of plasticizers which may be used as additives are polydimethylsiloxanes terminated by trimethylsilyl groups, silanol groups, or vinyl siloxanes, and diphenylsilanediol. Combinations of plasticizers like those mentioned may also be utilized. Examples of heat stabilizers which may be used as additives are transition metal salts of fatty acids such as iron octoate, transition metal silanolates such as iron silanolate, and cerium(IV) compounds. The organopolysiloxane material used may also be a conventional condensation-crosslinking organopolysiloxane, as described, for example, in EP0359251, or other known addition-crosslinking materials.

Each of the components used to prepare the organopolysiloxane material may be of the single material type or a mixture of two or more different materials, which together form the component. In some embodiments, the organopolysiloxane material comprises no additional components other than those described above. For example, in one such embodiment, the organopolysiloxane material is free of hydrophobic metal nitrides and carbides.

The composition comprises at least one of a metal oxide, a metal containing compound, boric acid, or zinc borate. When present, the metal oxide is selected from a group consisting of magnesium oxide, aluminum oxide, tin oxide, calcium oxide, titanium oxide, barium oxide, and mixtures thereof. When present, the metal-containing compound produces a metal oxide of the group listed above on heating. Examples of such metal-containing compounds include, for example, metal hydroxides. In some embodiments, the components mentioned above are provided in the composition in an amount of from 1.5 to 40% by weight, based always on the total weight of the composition, preferably from 10 to 20% by weight. Mixtures of the metal oxides, metal-containing compounds, boric acid, and zinc borate may also be used. For example, in some embodiments, two or more metal oxides may be present in the composition. In one such embodiment, the composition comprises aluminum oxide and magnesium oxide.

The composition comprises a platinum complex containing at least one unsaturated group. Preferably, the unsaturated group is a hydrocarbon group. Examples of preferable platinum complexes include platinum-olefin complexes, platinum-aldehyde complexes, platinum-ketone complexes, platinum-vinyl siloxane complexes or platinum-1,3-divinyl-1,1,3,3-tetramethyldisiloxane complexes with or without any detectable content of organic halogen, platinum-norbornadiene-methylacetonate complexes, bis(gamma-picoline)platinum dichloride, trimethylenedi-pyridineplatinum dichloride, dicyclopentadieneplatinum dichloride, (dimethylsulfoxide)(ethylene)platinum(II) dichloride, reaction products of platinum tetrachloride with olefins and with primary amines, secondary amine, or both primary and secondary amines for example the reaction product of sec-butylamine with platinum tetrachloride dissolved in 1-octene. In certain embodiments, the platinum complex is a platinum-vinyl siloxane complex. Preferably, the platinum-vinyl siloxane complex is a platinum-1,3-divinyl-1,1,3,3-tetramethyldisiloxane complex. However, other platinum-vinyl siloxane complexes may be suitable. The amounts of the platinum complex used are from 5 to 200 ppm, preferably from 10 to 100 ppm. The amount is based on elemental platinum. It is also possible to use mixtures of the platinum complexes in the composition.

The composition comprises hollow filler members. In some embodiments, the composition comprises 0.01-5 parts by weight of hollow filler members based on 100 parts by weight of the organopolysiloxane material. In one such embodiment, the composition comprises 0.1-5 parts by weight of hollow filler members based on 100 parts by weight of the organopolysiloxane material. In other embodiments, it may be preferred that the composition comprises 0.5-5 parts by weight of hollow filler members based on 100 parts by weight of the organopolysiloxane material.

Preferably, the hollow filler members are present in the composition in an unexpanded or pre-expanded state. In certain embodiments, the composition may comprise a mixture of unexpanded and pre-expanded hollow filler members.

The hollow filler members may be of any shape. However, in certain embodiments, it may be preferred that the hollow filler members are provided as spheres. In these embodiments, the hollow filler members may have a D50 value, which is a value representing the median value of the particle size distribution in the composition, of 10-500 μm. Preferably, the hollow filler members may have a D50 value of 10-200 μm. More preferably, the hollow filler members have a D50 value of 10-100 μm. Such micro-sized spheres may be referred to herein as microspheres.

In some embodiments, the hollow filler members may comprise a plurality of microspheres. Suitable microspheres may include a thermoplastic shell. The thermoplastic shell may be made of a polymer obtained from the polymerization of one or more monomers. Suitable monomers may be nitrite containing monomers such as acrylonitrile, methacrylo nitrile, α-chloroacrylo nitrile, α-ethoxyacrylo nitrile, fumaro nitrile, croto nitrile, acrylic esters such as methylacrylate or ethyl acrylate, methacrylic esters such as methyl methacrylate, isobornyl methacrylate, or ethyl methacrylate, vinyl halides such as vinyl chloride, vinylidene halides such as vinylidene chloride, vinyl pyridine, vinyl esters such as vinyl acetate, styrenes such as styrene, halogenated styrenes or α-methyl styrene, or dienes such as butadiene, isoprene and chloroprene. Mixtures of the monomers mentioned above may be utilized to form the polymer. Additionally, crosslinking multifunctional monomers known in the art may be utilized to form the polymer. In an embodiment, the monomers utilized to form the polymer are selected from the group consisting of vinylidene chloride, acrylonitrile, methacrylonitrile, acrylates and methacrylates. Most preferably, the microspheres comprise polyacrylonitrile.

Each microsphere may also contain a propellant. The propellant may be a gas or a liquid having a boiling temperature not higher than the softening temperature of the thermoplastic shell. Suitable propellants are known in the art.

Upon heating of the plurality of microspheres to a predetermined temperature, the propellant increases the internal pressure of the microsphere and the thermoplastic shell softens, which results in a significant expansion of each microsphere. Microspheres referred to herein as being pre-expanded have undergone the above described expansion before being mixed with the other components of the composition. Microspheres referred to herein as being unexpanded have not undergone the above described expansion before being mixed with the other components of the composition. Unexpanded microspheres may be expanded when, for example, the composition is being cured. In some embodiments, an expanded microsphere may have a diameter from about 2 to about 50 times the diameter of the microsphere in an unexpanded state.

In certain embodiments, the composition may be formed by a process that comprises mixing certain components mentioned above. The components can be mixed in a device such as, for example, an internal mixer or another suitable mixing device. The components may be added to the mixing device in a predetermined order and mixed at predetermined speed for a predetermined period of time.

After mixing, the composition is workable and easy to use in known processes such as, for example, extrusion processes. Utilizing an extrusion process, the compositon can be, for example, extruded and utilized to form an insulated member. For example, the composition may be included in, for example, a cable or a profile.

In certain embodiments, the cable, profile, or another member comprising the composition may comprise an elongated conductive member. The elongated conductive member may comprise a conductive metal such as, for example, copper, aluminum, silver, nickel, or another conductive member. In certain embodiments, the elongated conductive member may be a wire or a plurality of wires.

In some embodiments, the composition may be extruded onto the elongated conductive member. In these embodiments, the composition may be disposed around the elongated conductive member. An adhesion promotor may be provided to ensure that the composition adheres to the elongated conductive member. Adhesion promotors known in the art may be suitable for use in these embodiments. Examples of suitable adhesion promotors include commercially available promotors such as, for example, Geniosil® GF31 from Wacker-Chemie AG.

After being extruded onto the elongated conductive member, the composition may be cured. In an embodiment, after curing, the composition may form an insulating layer on and/or over the elongated conductive member. Preferably, the composition is cured for a predetermined time. In some embodiments, the composition is formed by curing the mixture at an ambient temperature. The time it takes for the mixture to be cured can be reduced by heating the mixture. In certain embodiments, the mixture can be heated to a temperature of 125° C. or more for curing. Preferably, the mixture is cured at a temperature in the range of about 125° C. to about 260° C. Other curing mechanisms such as, for example, moisture curing, peroxide curing, and radiation curing may be utilized to form the composition.

Preferably, curing results in the composition being elastomeric. Also, after curing, the composition permits sintering to start at temperatures as low as 610° C. In certain embodiments, this property allows the composition to produce a ceramic material at temperatures of 610° C. or more. In these embodiments, the composition is ceramifiable. Furthermore, it should be noted that the ceramic material formed in the event of fire is resistant to impact and shock.

Preferably, the composition exhibits a low density such as, for example, a density of 1.0 g/cm³ or less. In some embodiments, the density is 0.5-1.0 g/cm³. The density of the composition can be measured according to DIN 53 479 using a suitable device. An example of a suitable device for measuring density according to DIN 53 479 is an XS204 Densometer manufactured and sold by the Mettler Toledo.

The composition also exhibits a higher level of mechanical properties, better heat-ageing properties, and greater insulating capabilities than conventional silicone compositions, especially when exposed to high temperatures such as, for example, in temperatures above 900° C. For example, the composition may exhibit a dielectric constant of 2.8 or less at 25° C. with a frequency of 50 hertz (Hz). Preferably, the composition exhibits a dielectric constant of 2.3 or less at 25° C. with a frequency of 50 Hz. In some embodiments, the composition may exhibit a dielectric constant of 1.0-2.3 at 25° C. with a frequency of 50 Hz. Measuring the dielectric constant can be conducted after the composition has cured using a Quadtech 1659-9700 Dielectric System according to ASTM D150.

Further, the composition exhibits excellent mechanical properties. For example, in certain embodiments, the composition exhibits a tensile strength of 2.75 megapascal (MPa) or more. In one such embodiment, the composition exhibits a tensile strength of 2.75-8.5 MPa. The tensile strength of the composition can be measured according to ASTM D412 using a tensile tester. An example of a tensile tester suitable for use in measuring the tensile strength of the composition according to ASTM D412 is an Instron 3365 Tensile Tester. In some embodiments, the composition exhibits an elongation at break of 100 percent or more. In other embodiments, the composition exhibits an elongation at break of 200 percent or more. Preferably, the composition exhibits an elongation at break of 200-400 percent. The elongation of the composition can be measured according to ASTM D412 and when measuring tensile strength. In some embodiments, the composition exhibits a Shore A hardness of 50 or more. In these embodiments, the composition may exhibit a Shore A hardness of 70 or more. Preferably, the composition exhibits a Shore A hardness of 70-100. The Shore A hardness of the composition can be measured according to ASTM D2240 using a durometer. An example of a durometer suitable for measuring Shore A hardness according to ASTM D2240 is an Instron Conveloader. In still other embodiments, the composition exhibits a tear strength of 100 N/mm or more. In these embodiments, the composition may exhibit a tear strength of 100-150 pounds per inch. The tear strength of the composition can be measured according to ASTM D624, test die B specimens using an Instron 3365 Tensile Tester.

As noted above, the compostion exhibits good mechanical, heat-ageing, and insulating properties. Additionally, the composition may also exhibit excellent elastomeric and/or heat reflective properties. Thus, the composition has a wide range of applications including fire safety applications. Also, because of the above-mentioned properties, the compositon can be utilized to form insulated members such as, for example, cables and profiles, which comprise the composition. The cables may be communication or energy cables. The profiles may be foams or compact gaskets for fire-resistant screening for rooms, cabinets or safes, or layers for ablation control in the lining of rocket engines or in other aerospace systems.

### EXAMPLES

The following examples are presented solely for the purpose of further illustrating and disclosing the embodiments of the composition. Examples 2-5, which are described below, illustrate embodiments of the composition within the scope of the invention.

### Example 1

100 parts of a diorganopolysiloxane end-capped by trimethylsiloxy groups, composed of 99.93 mol percent of dimethylsiloxane units and 0.07 mol percent of vinylmethylsiloxane units and having a viscosity of 8*10⁶ mPa*s at 25° C. are mixed in a kneader operated at 150° C., first with 50 parts of silicon dioxide produced pyrogenically in the gas phase and having a surface area of 200 m²/g, then with 1 part of dimethylpolysiloxane end-capped by trimethylsiloxy groups and having a viscosity of 96 mPa*s at 25° C., next with 7 parts of a dimethylpolysiloxane having an Si-bonded OH group in each terminal unit and having a viscosity of 40 mPa*s at 25° C., with 36 parts of aluminum oxide having a particle size >10 μ and having an alkali metal oxide content of <0.5% by weight, and 0.3% by weight of a platinum-1,3-divinyl-1,1,3,3-tetramethyldisiloxane complex.

### Example 2

100 kilograms (kg) of Example 1, 1.15 kg of pre-expanded microspheres, which were sold as Expancel® 920 DE 80D 20 by Kish Company, 1.0 kg of magnesium oxide, which was sold as ELASTOMAG® 170 by Akrochem Corporation, 1.0 kg of a plasticizer sold as WACKER® PLASTICIZER X345 by Wacker Chemie AG, 2.0 kg of a colorant paste known as CBLU2 MB from Wacker Chemical Corporation, and 2.3 kg of bis(2,4-dichlorobenzoyl) peroxide sold as NOVIPER® DB50 by Novichem Co. were mixed using a 250 gallon closed-lid sigma mixer. A mixing speed of 117 rpm for 45 minutes was applied to achieve a uniform blend.

The composition of Example 2 was fed to an extruder with a crosshead that directed the composition onto a conductive member. Next, the coated conductive member was directed through a heated air tunnel, which was at a temperature of about 427° C. to about 649° C., at a predetermined speed to cure the composition. After curing, the composition of Example 2 exhibited a density of 0.95 g/cm³, a dielectric constant of 2.3, a tensile strength of 7.1 MPa, an elongation at break of 260 percent, a Shore A hardness of 73, and a tear strength of 124 pounds per inch. The specific gravity, dielectric constant, tensile strength at break, elongation at break, Shore A hardness, and tear strength were determined according to the methods specified above.

### Example 3

100 kilograms (kg) of Example 1, 1.35 kg of pre-expanded microspheres, which were sold as Expancel® 920 DE 80D 20 by Kish Company, 1.0 kg of magnesium oxide, which was sold as ELASTOMAG® 170 by Akrochem Corporation, 1.0 kg of a plasticizer sold as WACKER® PLASTICIZER X345 by Wacker Chemie AG, 2.0 kg of a colorant paste known as CBLU2 MB from Wacker Chemical Corporation, and 2.3 kg of bis(2,4-dichlorobenzoyl) peroxide sold as NOVIPER® DB50 by Novichem Co. were mixed using a 250 gallon sigma internal mixer. A mixing speed of 117 rpm for 45 minutes was applied to achieve a uniform blend.

The composition of Example 3 was fed to an extruder with a cross head that directed the composition onto a conductive member. Next, the coated conductive member was directed through a heated air tunnel, which was at a temperature of about 427° C. to about 649° C., at a predetermined speed to cure the composition. After curing, the composition of Example 3 exhibited a density of 0.61 g/cm³, a tensile strength of 5.3 MPa, an elongation at break of 256 percent, and a tear strength of 122 pounds per inch. The specific gravity, dielectric constant, tensile strength at break, elongation at break, Shore A hardness, and tear strength were determined according to the methods specified above.

### Example 4

100 kilograms (kg) of Example 1, 1.55 kg of pre-expanded microspheres, which were sold as Expancel® 920 DE 80D 20 by Kish Company, 1.0 kg of magnesium oxide, which was sold as ELASTOMAG® 170 by Akrochem Corporation, 1.0 kg of a plasticizer sold as WACKER® PLASTICIZER X345 by Wacker Chemie AG, 2.0 kg of a colorant paste known as CBLU2 MB from Wacker Chemical Corporation, and 2.3 kg of bis(2,4-dichlorobenzoyl) peroxide sold as NOVIPER® DB50 by Novichem Co. were mixed using a 250 gallon sigma internal mixer. A mixing speed of 117 rpm for 45 minutes was applied to achieve a uniform blend.

The composition of Example 4 was fed to an extruder with a crosshead that directed the composition onto a conductive member. Next, the coated conductive member was directed through a heated air tunnel, which was at a temperature of about 427° C. to about 649° C., at a predetermined speed to cure the composition. After curing, the composition of Example 4 exhibited a density of 0.44 g/cm³, a tensile strength of 4.4 MPa, an elongation at break of 216 percent, and a tear strength of 115 pounds per inch. The specific gravity, dielectric constant, tensile strength at break, elongation at break, Shore A hardness, and tear strength were determined according to the methods specified above.

### Example 5

100 kilograms (kg) of Example 1, 3.0 kg of pre-expanded microspheres, which were sold as Expancel® 920 DE 80D 20 by Kish Company, 1.0 kg of magnesium oxide, which was sold as ELASTOMAG® 170 by Akrochem Corporation, 1.0 kg of a plasticizer sold as WACKER® PLASTICIZER X345 by Wacker Chemie AG, 2.0 kg of a colorant paste known as CBLU2 MB from Wacker Chemical Corporation, and 2.3 kg of bis(2,4-dichlorobenzoyl) peroxide sold as NOVIPER® DB50 by Novichem Co. were mixed using a 250 gallon closed-lid sigma mixer. A mixing speed of 117 rpm for 45 minutes was applied to achieve a uniform blend.

The composition of Example 5 was fed to an extruder with a cross head that directed the composition onto a conductive member. Next, the coated conductive member was directed through a heated air tunnel, which was at a temperature of about 427° C. to about 649° C., at a predetermined speed to cure the composition. After curing, the composition of Example 5 exhibited a density of 0.40 g/cm³,a tensile strength of 3.5 MPa, an elongation at break of 191 percent, and a tear strength of 108 pounds per inch. The specific gravity, dielectric constant, tensile strength at break, elongation at break, Shore A hardness, and tear strength were determined according to the methods specified above.

From the foregoing detailed description, it will be apparent that various modifications, additions, and other alternative embodiments are possible without departing from the true scope and spirit. The embodiments discussed herein were chosen and described to provide the best illustration of the principles of the invention and its practical application to thereby enable one of ordinary skill in the art to use the invention in various embodiments and with various modifications as are suited to the particular use contemplated. As should be appreciated, all such modifications and variations are within the scope of the invention.

1-18 (canceled)

19. A composition comprising:
(a) a curable organopolysiloxane material;
(b) at least one of a metal oxide selected from a group consisting of magnesium oxide, aluminum oxide, tin oxide, calcium oxide, titanium oxide and barium oxide, a metal-containing compound which produces a metal oxide of the group on heating, boric acid, or zinc borate;
(c) a platinum complex containing at least one unsaturated group; and
(d) hollow filler members, wherein the hollow filler members comprise a plurality of unexpanded microspheres, pre-expanded microspheres, or a mixture thereof, and are present in an amount of 0.01-5 parts by weight based on 100 parts by weight of the curable organopolysiloxane material.

20. The composition of claim 19, wherein the composition exhibits a dielectric constant of 2.8 or less when measured using a Quadtech 1659-9700 dielectric system according to ASTM D150.

21. The composition of claim 19, wherein wherein the composition produces a ceramic material at temperatures of 610° C. or more.

22. The composition of claim 19, wherein the curable organopolysiloxane material is peroxidically crosslinkable or condensation crosslinkable.

23. The composition of claim 19, wherein the platinum complex is a platinum-vinyl siloxane complex.

24. The composition of claim 23, wherein the platinum-vinyl siloxane complex is a platinum-1,3-divinyl-1, 1,3,3-tetramethyldisiloxane complex.

25. The composition of claim 19, wherein the curable organopolysiloxane material comprises a vinyl-functional organopolysiloxane and a silanol-functional organopolysiloxane.

26. The composition of claim 19, wherein the composition comprises the plurality of pre-expanded microspheres.

27. The composition of claim 26, wherein the plurality of pre-expanded microspheres have a D50 value, which is a value representing the median value of the particle size distribution in the composition, of 10-500 μm.

28. The composition of claim 19, further comprising a reinforcing filler, a nonreinforcing filler, or mixture thereof.

29. The composition of claim 28, wherein the reinforcing filler comprises silica.

30. A process for forming an insulated member, comprising:
forming a composition as claimed in claim 19 by mixing components (a) through (d);
extruding the composition onto an elongated conductive member; and
curing the composition.

31. The process of claim 30, wherein the composition is cured at a temperature of 125° C. or more.

32. The process of claim 30, wherein the composition is disposed around the elongated conductive member and, after curing, forms an insulating layer that exhibits a dielectric constant of 2.8 or less.

33. A cable wherein insulation for a conductor comprises the composition of claim 19.

34. A profile which comprises the composition of claim 19.

35. The composition of claim 19, wherein the thermoplastic shell comprises polyacrylonitrile and contains a propellant.

36. The composition of claim 19, wherein the hollow filler members comprise a plurality of pre-expanded microspheres, each microsphere comprising a thermoplastic shell and a propellant.

37. The composition of claim 19, wherein the composition exhibits a density of 1.0 g/cm³ or less, when measured according to DIN 53 479, and a dielectric constant of 1.0-2.3 at 25° C. with a frequency of 50 hertz (Hz), when measured according to ASTM D150.

38. The composition of claim 36, wherein the thermoplastic shell comprises a polymer formed from the polymerization of one or more monomers and the monomers are selected from the group consisting of vinylidene chloride, acrylonitrile, methacrylonitrile, acrylates and methacrylates.
